(19) United States
(12) Patent Application Publication
(10) Pub. No.: US 2025/0128645 A1
(43) Pub. Date: Apr. 24, 2025

(54) Systems and Methods for Cooling a Secondary Battery Used for Underground Mining Machines

(71) Applicant: Caterpillar Underground Mining Pty. Ltd., South Burnie (AU)

(72) Inventors: Venkata Subba Reddy Atluri, Park Grove (AU); Domenic Raoul Albert, Aurora, IL (US); Zhijun Cai, Dunlap, IL (US); Erick Alan Njos, Sahuarita, AZ (US); Sivakumar Ramasamy, Tamil Nadu (IN)

(73) Assignee: Caterpillar Underground Mining Pty. Ltd., South Burnie (AU)

(21) Appl. No.: 18/920,504

(22) Filed: Oct. 18, 2024

(30) Foreign Application Priority Data
Oct. 20, 2023 (IN) 202311071681

(51) Int. Cl. B60L 58/26; B60H 1/00; B60H 1/32; B60K 11/02; B60L 50/60; H01M 10/613; H01M 10/625; H01M 10/63; H01M 10/6568; H01M 10/663

(52) U.S. Cl. CPC B60L 58/26; B60H 1/00278; B60H 1/3211; B60K 11/02; B60L 50/60; H01M 10/613; H01M 10/625; H01M 10/63; H01M 10/6568; H01M 10/663; B60H 2001/00307; B60H 2001/3272; B60H 2001/3285; B60L 2200/40; H01M 2220/20

(57) ABSTRACT

A work machine includes a tank of secondary battery coolant to act as a heat sink to cool a secondary battery. When a power unit is available for use to provide electrical power to the work machine, a secondary battery cooling system is used. The secondary battery cooling system includes a tank used to store secondary battery coolant. The secondary battery coolant stored in the tank is maintained within a temperature range using the refrigerant of an HVAC system that used to cool the cab of the work machine. When the power unit is available for use, the HVAC system is fluidically disconnected from cooling the secondary battery coolant stored in the tank. Thereafter, the secondary battery is cooled using the secondary battery coolant stored in the tank. Thus, the secondary battery coolant stored in the tank acts as a heat sink to remove heat from the secondary battery until the power unit is available for use.

### TECHNICAL FIELD

The present disclosure relates to a battery cooling system. More specifically, the present disclosure relates to the use of a cooling system when a power unit is removed from an underground mining machine during a primary unit swap.

### BACKGROUND

Heavy duty work machines, such as earth-moving vehicles or hauling trucks, require significant power to carry out their functions. The machines themselves can be of substantial weight, and their loads require large amounts of power to move. Diesel engines have been used to provide that power, but the use of combustion engines in substantially enclosed (e.g., underground) mining spaces can present several challenges. For example, the exhaust from combustion engines needs to be effectively removed from underground routes in order to maintain an atmosphere hospitable to workers and reduce the addition of pollutants into the ground and the atmosphere. Further, these machines are used to move large loads of material along underground and above-ground haul routes over large distances. Supplies of diesel fuel may be far away from such locations or not easily delivered to such locations.

Electrical power has been used to supplement or replace diesel engines in these mining machines. In some environments, the electrical power is delivered from one or more batteries. The batteries are used to provide power to electrical motors to move the work machine as well as power to various electrical systems used to operate the work machine. These batteries can be charged while installed on the machine if a suitable connection and power source are available. In other examples, the batteries can be swapped whereby a discharged battery is removed and a charge battery is installed. In some examples, batteries used to power work machines require some form of cooling during use. For example, in low power situations, the battery may be cooled by the air surrounding the battery. In other examples where the power is sufficient that some additional cooling is required, the batteries may be cooled using forced air induction or refrigerants.

One approach for cooling a battery using a liquid is described in International Patent App. Pub. No. WO 2010/016771A2 (“the '7719 application”). The '771 application describes a battery with cooling channels. Coolant flows within the cooling channels, removing heat generated in various parts of the battery. The heated coolant is cooled and circulated back into the system in a closed loop. An expansion tank is used to store excess coolant and to make up for a loss of coolant in case of a leak. A heat exchanger is used to cool the heated coolant. However, the system of the '771 application may not be suitable for use in various applications. For example, if the cooling fluid in the heat exchanger, the fluid used to cool the coolant heated by the battery, is not available for use, the temperature of the battery may not be maintained below a certain temperature. In other examples, it may be undesirable to cool the cooling fluid in the heat exchanger in some situations. For example, a machine using the battery may be relying solely on the battery to provide electrical power to one or more components of the machine. If power from the battery is needed to cool the fluid in the heat exchanger, the battery reserve power may be quickly depleted. Thus, the battery may need to be removed from use before the battery is damaged from a high temperature. As a result, the system described in the '771 application may lack range and may be susceptible to extended periods of downtime.

Examples of the present disclosure are directed to overcoming deficiencies of such systems.

### SUMMARY

In one aspect of the presently disclosed subject matter, a work machine is described. The work machine includes a power unit configured to provide electrical power to a first set of electrical systems of the work machine, a secondary battery configured to provide electrical power to a second set of electrical systems of the work machine, and a work machine cooling system comprising a heating, ventilation, and cooling (HVAC) system configured to maintain a temperature of air within a cab of the work machine, wherein the HVAC system is further configured to provide at least a portion of a coolant to a battery cooling system, the battery cooling system, comprising a tank configured to store a volume of a secondary battery coolant, wherein the volume of the secondary battery coolant removes heat from the secondary battery when the power unit is unavailable for use a chiller configured to receive the refrigerant from the HVAC system, wherein the chiller is a heat exchanger configured to maintain a temperature of the secondary battery coolant in the tank within a range of temperatures, and a tramming coolant pump in fluidic communication with the tank, wherein the tramming coolant pump is configured to pump the secondary battery coolant from the tank into the secondary battery to maintain a temperature of the secondary battery below a battery setpoint.

In an additional aspect of the presently disclosed subject matter, a controller configured to control a work machine cooling system of a work machine is described. The controller includes a memory storing computer-executable instructions, and a processor in communication with the memory, the computer-executable instructions causing the processor to perform acts comprising receiving an input that a power unit of the work machine is unavailable for use, whereby a battery cooling system of a work machine cooling system will be used to cool a secondary battery, wherein the work machine cooling system comprises a heating, ventilation, and cooling (HVAC) system configured to maintain a temperature of air within a cab of the work machine, wherein the HVAC system is further configured to provide at least a portion of a refrigerant to the battery cooling system when the power unit is unavailable for use, and the battery cooling system, comprising a tank configured to store a volume of a secondary battery coolant, wherein the volume of the secondary battery coolant removes heat from the secondary battery when the power unit is unavailable for use, a chiller configured to receive the refrigerant from the HVAC system, wherein the chiller is a heat exchanger configured to maintain a temperature of the secondary battery coolant in the tank within a range of temperatures, and a tramming coolant pump in fluidic communication with the tank, wherein the tramming coolant pump is configured to pump the secondary battery coolant from the tank into the secondary battery to maintain a temperature of the secondary battery below a battery setpoint, and receiving a cab cooling input and a secondary battery cooling input to cause the work machine cooling system to enter a configuration based on the cab cooling input and the secondary battery cooling input.

In a still further aspect of the presently disclosed subject matter, a method for controlling a work machine cooling system of a work machine is described. The method includes receiving an input that a power unit of the work machine is unavailable for use, whereby a battery cooling system of a work machine cooling system will be used to cool a secondary battery, wherein the work machine cooling system comprises, a heating, ventilation, and cooling (HVAC) system configured to maintain a temperature of air within a cab of the work machine, wherein the HVAC system is further configured to provide at least a portion of a refrigerant to the battery cooling system when the power unit is unavailable for use, and the battery cooling system, comprising a tank configured to store a volume of a secondary battery coolant, wherein the volume of the secondary battery coolant removes heat from the secondary battery when the power unit is unavailable for use, a chiller configured to receive the refrigerant from the HVAC system, wherein the chiller is a heat exchanger configured to maintain a temperature of the secondary battery coolant in the tank within a range of temperatures, and a tramming coolant pump in fluidic communication with the tank, wherein the tramming coolant pump is configured to pump the secondary battery coolant from the tank into the secondary battery to maintain a temperature of the secondary battery below a battery setpoint, and receiving a cab cooling input and a secondary battery cooling input to cause the work machine cooling system to enter a configuration based on the cab cooling input and the secondary battery cooling input.

### BRIEF DESCRIPTION OF DRAWINGS

FIG. 1 illustrates an isometric view of a work machine within an XYZ coordinate system as one example suitable for carrying out the principles discussed in the present disclosure.

FIG. 2 illustrates a secondary battery cooling system using a cooling tank as a heat sink, in accordance with one or more examples of the present disclosure.

FIG. 3 illustrates an example control strategy of a work machine cooling system, in accordance with one or more examples of the present disclosure.

FIG. 4 is a flowchart depicting a method for controlling the work machine cooling system, in accordance with one or more examples of the present disclosure.

FIG. 5 depicts a component level view of a controller for use with the systems and methods described herein, in accordance with various examples of the presently disclosed subject matter.

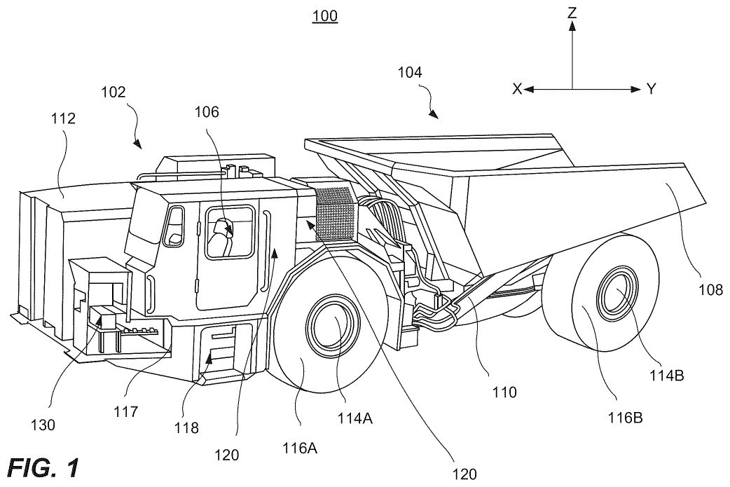

### DETAILED DESCRIPTION

Wherever possible, the same reference numbers will be used throughout the drawings to refer to same or like parts. FIG. 1 illustrates an isometric view of a work machine 100 within an XYZ coordinate system as one example suitable for carrying out the principles discussed in the present disclosure. The example work machine 100 travels along a mining route, typically from a source to a destination within a worksite. In one implementation as illustrated, work machine 100 is a hauling machine that hauls a load within or from a worksite within an underground mining operation. For instance, in some examples, the work machine 100 is configured to haul excavated ore or other earthen materials from an excavation area along a haul route to dump sites and then return to the excavation area. In this arrangement, the work machine 100 may be one of many similar machines configured to ferry earthen material in a trolley arrangement. While a large, underground mining truck in this instance, the work machine 100 may be any machine that carries a load between different locations within a worksite, examples of which include an articulated truck, an off-highway truck, an on-highway dump truck, a wheel tractor scraper, an underground load, haul, and dump (LHD) machine, or any other similar machine. Alternatively, the work machine 100 may be an off-highway truck, on-highway truck, a dump truck, an articulated truck, a loader, an excavator, a pipe layer, or a motor grader. In other implementations, the work machine 100 need not haul a load and may be any machine associated with various industrial applications including, but not limited to, mining, agriculture, forestry, construction, and other industrial applications.

Referring to FIG. 1, an example work machine 100 includes a front section 102 and a rear section 104. In some examples, the front section 102 is movably connected to the rear section through an articulated connector, not shown. In some examples, the front section 102 and the rear section 104 are independently movable in multiple axis of rotation, allowing the front section 102 a degree of movement independent of the rear section 104. The work machine 100 further includes a cab 106. The cab 106 can be a climate-controlled, interior space in which one or more operators of the work machine 100 occupies during the operation of the work machine 100. The work machine further includes a bucket 108 installed at the rear section 104 of the work machine 100. The bucket 108 is used as the volume in which mined material or other material may be placed for transport. The bucket 108 is raised and lowered using hydraulic pistons, an example of which is illustrated in FIG. 1 as piston 110.

The work machine 100 further includes a power unit 112 that provides power to various electrical equipment of the work machine 100. The power unit 112 houses one or more set or assemblies of batteries (not illustrated) that provide direct current power to the work machine 100. The power unit 112 provides electrical power to wheel assemblies, identified as wheel assembly 114A and wheel assembly 114B, with complimentary wheel assemblies on the other side of the work machine 100, not shown. The wheel assemblies 114A and 114B comprise electrical motors that receive power from the power unit 112 through one or more inverters, not shown. The inverters convert the direct current power provided by the batteries in the power unit 112 into alternating current used by the electrical motors of the wheel assemblies 114A and 114B. The polarity and power provided by the inverters to the wheel assemblies 114A and 114B causes the electrical motors of the wheel assemblies 114A and 114B to rotate, thereby rotating tires 116A and 116B respectively.

In some examples, the power unit 112 is unavailable for use. In some configurations of the work machine 100, the power unit 112 is removable. In other examples, the power unit 112 is discharged to a degree that the power unit 112 cannot provide power at a required level. Another example is a situation in which the power unit 112 is damaged or otherwise electrically disconnected from the work machine 100. In these examples during which the power unit 112 is unavailable for use, a secondary battery 118 is used. In some examples, the secondary battery 118 is used to move the work machine 100 along a haul route by providing electrical power to the wheel assemblies 114A and 114B. In still further examples, the secondary battery 118 provides power to other electrical loads, such as, but not limited to, a heating, ventilation, and cooling (HVAC) system 120. The HVAC system 120 is used to heat or cool air within the cab 106. In some examples, the secondary battery 118 is used to supplement or augment electrical power provided by the power unit 112 in certain conditions, such as when the power unit 112 is fully discharged and is being changed out for a fully charged the power unit 112.

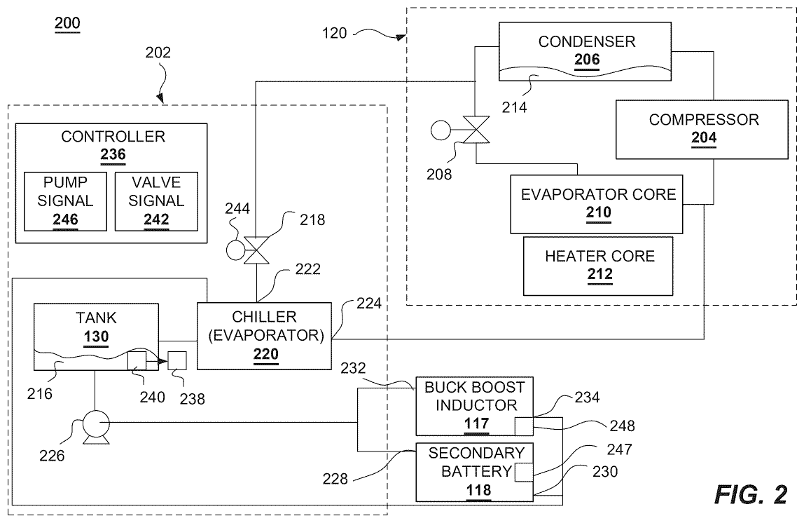

Thus, in some examples, while the power unit 112 is electrically connected to the work machine 100 to provide electrical power to the work machine 100, a portion of an HVAC refrigerant (not shown) used in the HVAC system 120 is ported to a chiller (or evaporator) of a secondary battery cooling system (illustrated in FIG. 2). The chiller can be a heat exchanger that reduces a temperature of a secondary battery cooling system coolant. At least a portion of the secondary battery cooling system coolant is stored in a cooling tank 130. The temperate of the secondary battery cooling system coolant stored in the cooling tank 130 is maintained within a temperature range, generally from 10 degrees Celsius to 35 degrees Celsius, though other ranges may be used and are considered to be within the scope of the presently disclosed subject matter.

The level (or volume) of the secondary battery cooling system coolant stored in the cooling tank 130 is maintained within a range of levels based on heat sink needs. For example, the volume of the secondary battery cooling system coolant stored in the cooling tank 130 may be calculated based on an estimation of heat generated by the secondary battery 118 while the power unit 112 is being replaced, the thermal characteristics of the secondary battery cooling system coolant stored in the cooling tank 130, an estimated time that the secondary battery cooling system coolant stored in the cooling tank 130 may be used to cool the secondary battery 118, the ambient temperature, and the like. Additional considerations may include space available in the work machine 100 to install the cooling tank 130, thus potentially limiting the volume available. The presently disclosed subject matter is not limited to any particular method of calculating the volume nor any specific factors used in the determination. In some examples, when the power unit 112 is electrically disconnected from the work machine 100, the cooling tank 130 is used to remove heat generated by the secondary battery 118, explained in more detail in FIG. 2.

FIG. 2 illustrates a work machine cooling system 200 using a cooling tank 130 as a heat sink, in accordance with one or more examples of the present disclosure. Illustrated in FIG. 2 are the HVAC system 120 and a battery cooling system 202. As mentioned above in FIG. 1, the HVAC system 120 may be used to reduce a temperature of the air within the cab 106. Although different types of HVAC systems may be used, an example of the HVAC system 120 may include a compressor 204, a condenser 206, an HVAC expansion valve 208, an evaporator core 210, and a heater core 212. The evaporator core 210 is a heat exchanger used to provide cool air to the cab 106 by absorbing heat from the air in the interior of the cab 106 into a refrigerant 214. The refrigerant 214 may be various types of refrigerants including, but not limited to, compressive refrigerants such as R22, R410A, R32, R134a, R513A, R1234yf, and the like. As will be explained in more detail below, other types of refrigerants may be used including non-compressive refrigerants. The use of the compressor 204 for compressive refrigerants is merely an example and not intended to limit the scope of the presently disclosed subject matter to compressive refrigerants.

Continuing with FIG. 2, the heater core 212 can be a heat exchanger used to add heat to the cab 106. The refrigerant 214, if used to absorb heat, enters the compressor 204 at an increased temperature than when entering the evaporator core 210. The HVAC expansion valve 208 allows compressed refrigerant 214 leaving the condenser 206 to rapidly expand, causing the temperature of the refrigerant 214 entering the evaporator core 210 to decrease, providing for the absorption of heat from the air in the cab 106. The refrigerant 214 may leave the evaporator core 210 at a higher temperature and enter the compressor 204, which compresses the refrigerant 214. The condenser 206 removes a portion of the heat in the refrigerant 214, allowing the refrigerant 214 to condense into a liquid and continue the cooling cycle.

As mentioned above, the HVAC system 120 may be used to cool a coolant used to cool the secondary battery 118 while the power unit 112 is electrically disconnected or is otherwise unable to provide a required amount of electrical power, from the work machine 100. In these examples, a portion of the refrigerant 214 used in the HVAC system 120 may be used to reduce the temperature of a secondary battery coolant 216 stored in the tank 130. The secondary battery coolant 216 is used to remove heat from the secondary battery 118. In some examples, the secondary battery coolant 216 is comprised of water, a water solution, a compressible refrigerant, glycol, an oil, or various solutions thereof. A portion of the refrigerant 214 enters a tramming expansion valve 218, where the refrigerant 214 expands, reducing the temperature of the refrigerant 214. The refrigerant 214 exits the tramming expansion valve 218 and enters a tramming chiller 220 through refrigerant inlet 222 and exits out refrigerant outlet 224. The refrigerant 214 exiting the refrigerant outlet 224 reenters the compressor 204 of the HVAC system 120. The refrigerant 214 entering the chiller 220 is used to reduce a temperature of the secondary battery coolant 216.

A portion of the secondary battery coolant 216 is stored in the tank 130 and provided to various components of the work machine 100. A tramming coolant pump 226 is in fluidic communication with the secondary battery coolant 216 in the tank 130 and is configured to pump the secondary battery coolant 216 into the secondary battery 118 through battery inlet 228 and exits through battery outlet 230. The secondary battery coolant 216 exits the battery outlet 230 and enters the chiller 220, whereby heat absorbed into the secondary battery coolant 216 from the secondary battery 118 is removed by the refrigerant 214 in the chiller 220. In some examples, the refrigerant 214 in the chiller 220 may be used to remove heat from other devices, such as the buck booster inductor 117. In this example, a portion of the secondary battery coolant 216 removes heat from the buck boost inductor 117, entering the buck boost inductor through buck inlet 232 and exiting the buck boost inductor 117 out buck outlet 234, whereby heat absorbed into the secondary battery coolant 216 from the buck boost inductor 117 is removed by the refrigerant 214 in the chiller 220.

In some examples, a temperature of the secondary battery coolant 216 stored in the tank 130 is maintained within a temperature range by controller 236. The controller 236 may be a computer-based system having one or more computer-readable storage media that, when executed by one or more processors, allows the controller 236 to receive various signals, process the signals, and transmit instructions to cause the manipulation of one or more devices of the work machine cooling system 200. In some examples, as mentioned above, the temperature of the secondary battery coolant 216 may be maintained within a temperature range. In these examples, the controller 236 may receive a temperature signal 238 from a temperature probe 240. The temperature signal 238 may be an indication of the temperature of the secondary battery coolant 216 in the tank 130. The controller 236 receives the temperature signal 238 and determines if additional or less cooling of the secondary battery coolant 216 is required. For example, the temperature signal 238 may indicate a temperature greater than a high setpoint. In this example, the controller 236 determines that more or additional cooling is required. Similarly, the temperature signal 238 may indicate a temperature lower than a low setpoint. In this example, the controller 236 determines that less cooling is required. If additional cooling of the secondary battery coolant 216 is required, the controller 236 may issue a valve signal 242 to open the tramming expansion valve 218. The valve signal 242 may cause the solenoid 244 of the tramming expansion valve 218 to operate, causing the tramming expansion valve 218 to open, thus providing an increased amount of the refrigerant 214 into the chiller 220, increasing the amount of heat removed from the secondary battery coolant 216, thus reducing the temperature of the secondary battery coolant 216. If less cooling of the secondary battery coolant 216 is required (i.e., the secondary battery coolant 216 is at or below the temperature range), the controller 236 may issue the valve signal 242 to close the tramming expansion valve 218. The valve signal 242 may cause the solenoid 244 of the tramming expansion valve 218 to operate, causing the tramming expansion valve 218 to close, thus providing a decreased amount of the refrigerant 214 into the chiller 220, decreasing the amount of heat removed from the secondary battery coolant 216. As a result, the rate of the reduction of the temperature of the secondary battery coolant 216 may be reduced, allowing the temperature to stabilize or increase to either stay or increase to be within the desired temperature range.

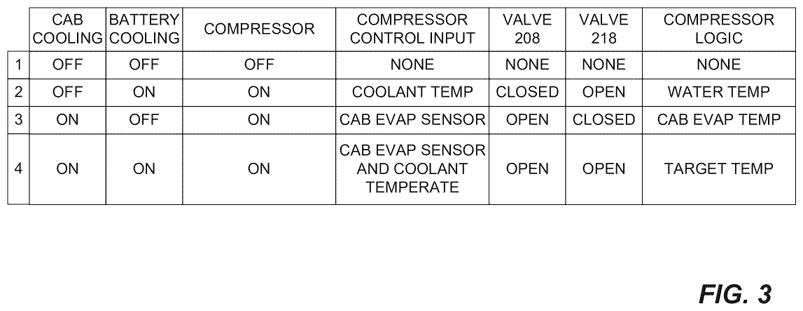

In some examples, the controller 236 may control the speed of the tramming coolant pump 226 using a pump signal 246 to control the cooling of the secondary battery 118 and/or the buck boost inductor 117. The controller 236 may issue the pump signal 246 to increase the pump speed of the tramming coolant pump 226 increase the amount of the secondary battery coolant 216 to the secondary battery 118 and/or the buck boost inductor 117. The controller The controller 236 may issue the pump signal 246 to decrease the pump speed of the tramming coolant pump 226, thus providing a decreased amount of the secondary battery coolant 216 to the secondary battery 118 and/or the buck boost inductor 117, allowing the temperature of the secondary battery 118 and/or the buck boost inductor 117 to be within a desired temperature range of the secondary battery 118 and/or the buck boost inductor 117. A battery temperature probe 247 may be used to provide a temperature of the secondary battery 118 and an inductor probe 248 may be used to provide a temperature of the buck boost inductor 117. In some examples, the compressor 204, the HVAC expansion valve 208, and the tramming expansion valve 218 may be operated in a manner to provide for the cooling of the cab 106 and the secondary battery 118, an example strategy of which is illustrated in FIG. 3, below.

FIG. 3 illustrates an example control strategy 300 of the work machine cooling system 200 for different operational scenarios, in accordance with one or more examples of the present disclosure. The control strategy provides for the operation of the compressor 204, the HVAC expansion valve 208, and the tramming expansion valve 218. Illustrated in FIG. 3 are various configurations identified as 1-4, with the applicable inputs/outputs in the same row. In configuration 1, cab cooling is off and battery cooling is off. Configuration 1 represents a scenario such as when the work machine 100 is off and shut down. In this configuration 1, cooling is not required for either the cab 106 or the secondary battery 118. Thus, the compressor 204 is off and no input is being provided to the compressor 204. No control inputs are being provided to the HVAC expansion valve 208 or the tramming expansion valve 218. Further, the compressor 204 cycles are not being controlled. In configuration 2, cab cooling is off and battery cooling is on. Configuration 2 can represent a scenario when cab 106 cooling is not needed. Another scenario for configuration 2 may be if cab 106 cooling may not be available or desired, such as the temperature of the secondary battery 118 is above a battery setpoint and most of the cooling capable is to be used for cooling the secondary battery 118. In this configuration 2, the compressor 204 is on and the speed of the compressor 204 is controlled by the temperature of the secondary battery coolant 216. As mentioned above, most of the cooling may be needed to cool the secondary battery 118, so the HVAC expansion valve 208 is closed and the tramming expansion valve 218 is open. The compressor logic is based on the temperature of the secondary battery coolant 216. For example, the compressor 204 may be energized if the temperature of the secondary battery coolant 216 is at or above 25 degrees Celsius and deenergized if the temperature of the secondary battery coolant 216 is below 25 degrees Celsius.

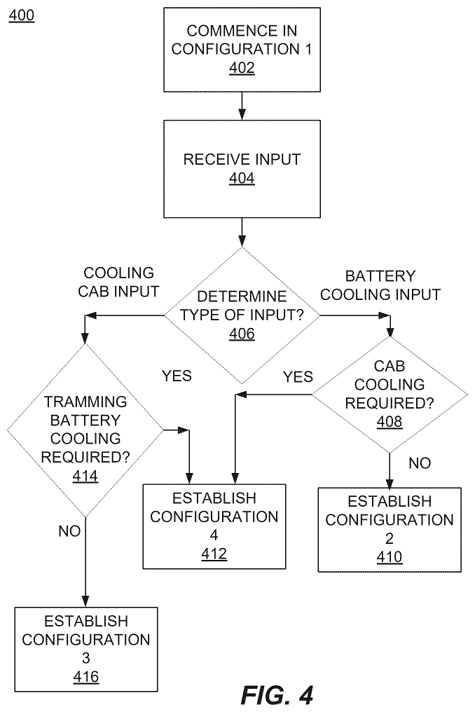

In configuration 3, the cab 106 is being cooled and the secondary battery 118 is not being cooled. In this configuration 3, the compressor 204 is on and the speed of the compressor 204 is controlled by the temperature of the cab 106. The HVAC expansion valve 208 is open and, because no cooling is needed for the secondary battery 118, the tramming expansion valve 218 is closed. The compressor logic is based on the temperature of the cab 106. In configuration 4, both the cab 106 and the secondary battery 118 are being cooled. In this configuration 4, both the battery temperature and the cab are inputs to the compressor. Because both the cab 106 and the secondary battery 118 are being cooled, both the HVAC expansion valve 208 and the tramming expansion valve 218 are open. The compressor speed is controlled by the temperature of the cab 106 and a temperature of the secondary battery coolant 216. The HVAC expansion valve 208 and the tramming expansion valve 218 may be opened and closed to maintain the temperature of the cab 106 and the secondary battery 118 below their respective temperature setpoints (i.e., battery setpoint or cab air temperature setpoint) or within their respective temperature ranges. In some examples, the controller 236 can close and open the HVAC expansion valve 208 and/or the tramming expansion valve 218 to divert cooling to either system. Further, a high setpoint of the cab 106 or the secondary battery 118 may be used as an overriding setpoint. For example, a high setpoint of 100 degrees Celsius in the cab 106 may be used to cause the HVAC expansion valve 208 to open and the tramming expansion valve 218 to close, thus diverting all cooling to the cab 106 to keep the temperature of the cab 106 safe for personnel. In a similar manner, a high setpoint of 40 degrees Celsius in secondary battery coolant 216 (indicating an overtemperature condition of the secondary battery 118) may be used to cause the HVAC expansion valve 208 to close and the tramming expansion valve 218 to open, thus diverting all cooling to secondary battery 118 to reduce the potential of damage to the secondary battery 118 caused by an overtemperature condition. A method for providing the control strategies of FIG. 3 is provided in FIG. 4, below.

FIG. 4 is a flowchart depicting a method 400 for controlling the work machine cooling system 200, in accordance with various examples of the presently disclosed subject matter. The method 400 and other processes described herein are illustrated as example flow graphs, each operation of which may represent a sequence of operations that can be implemented in hardware, software, or a combination thereof. In the context of software, the operations represent computer-executable instructions stored on one or more tangible computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

The method 400 commences at step 402, where the work machine cooling system 200 is in configuration 1. In configuration 1, cab cooling is off and battery cooling is off, the compressor 204 is off, and no input is being provided to the compressor 204. No control inputs are being provided to the HVAC expansion valve 208 or the tramming expansion valve 218. Further, the compressor 204 cycles are not being controlled.

At step 404, the controller 236 receives an input from the work machine 100. The input can be that cooling is to be provided to the secondary battery 118. In some examples, the input can be that cooling to the cab is to be provided. The input may be received from the work machine 100 in situations such as the power unit 112 is to be removed or the power unit 112 is not charged sufficiently to provide power to the work machine 100.

At step 406, the controller 236 determines, what type of input was received in step 404. For example, in instances in which the power unit 112 is or will be unavailable for use to provide electrical power, the work machine 100 provides the input to the controller 236 indicating that the secondary battery 118 will be used to provide power. As noted above, cooling may be required for the secondary battery 118 while the power unit 112 is electrically disconnected from the work machine 100 or is otherwise unusable to provide electrical power to the work machine 100.

If at step 406, the controller 236 determines the input is a requirement that battery cooling is required, the method continues to step 408, where the controller 236 determines if cab cooling is required. For example, the controller 236 request an input from the HVAC system 120 if the HVAC system 120 is being used to provide cooling to the cab 106. If cab cooling is not required as determined at step 408 by the controller 236, at step 410, the controller 236 establishes configuration 2. In configuration 2, the compressor 204 is on and the speed of the compressor 204 is controlled by the temperature of the secondary battery coolant 216. The HVAC expansion valve 208 is closed and the tramming expansion valve 218 is open. The compressor logic is based on the temperature of the secondary battery coolant 216. For example, the compressor 204 may be energized if the temperature of the secondary battery coolant 216 is at or above 25 degrees Celsius and deenergized if the temperature of the secondary battery coolant 216 is below 25 degrees Celsius. The method 400 continues to step 404.

If at step 408 the controller 236 determines that cab cooling is required, the controller 236 establishes configuration 4 at step 412. In configuration 4, the battery temperature, the coolant temperature, and the cab temperature are inputs to the compressor. The HVAC expansion valve 208 and the tramming expansion valve 218 are open. The compressor 204, the HVAC expansion valve 208 and the tramming expansion valve 218 are controlled based on the temperature of the cab 106 and the temperature of the secondary battery 118. The HVAC expansion valve 208 and the tramming expansion valve 218 may be opened and closed to maintain the temperature of the cab 106 and the secondary battery 118 below their respective temperature setpoints or within their respective temperature ranges. The method 400 continues to step 404.

If at step 406 the controller 236 determines the input is that cab cooling is required, the method 400 continues to step 414. At step 406, the controller 236 may receive an input that cab cooling is required. For example, the controller 236 requests an input from the HVAC system 120 if the HVAC system 120 is being used to provide cooling to the cab 106. It should be noted that, the controller 236 may receive the input of step 404 at various steps of the method 400. For example, the method 400 may be at step 408, whereby the controller 236 has established configuration 2 (no cab cooling) and receive another input at step 404, wherein cab cooling is required.

Continuing with method 400, in response to receiving the input that cab cooling is required, the method continues to step 414, where the controller determines if battery cooling is required. If at step 414 the controller 236 determines that secondary battery cooling is required, the method 400 continues to step 412, whereby the controller 236 establishes configuration 4. If at step 414 the controller 236 determines that secondary battery cooling is not required, the method 400 continues to step 416 whereby the controller 236 establishes configuration 3. In configuration 3, the cab 106 is being cooled and the secondary battery 118 is not being cooled. In this configuration 3, the compressor 204 is on and the speed of the compressor 204 is controlled by the temperature of the cab 106. The HVAC expansion valve 208 is open and, because no cooling is needed for the secondary battery 118, the tramming expansion valve 218 is closed. The compressor logic is based on the temperature of the cab 106.

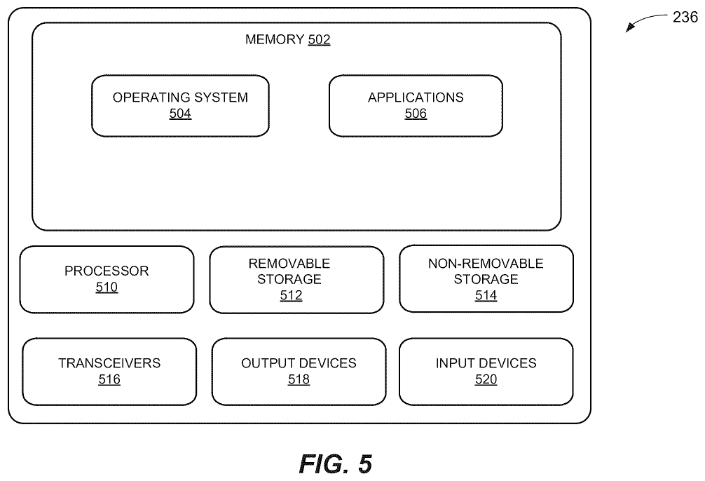

FIG. 5 depicts a component level view of the controller 236 for use with the systems and methods described herein, in accordance with various examples of the presently disclosed subject matter. The controller 236 could be any device capable of providing the functionality associated with the systems and methods described herein. The controller 236 can comprise several components to execute the above-mentioned functions. The controller 236 may be comprised of hardware, software, or various combinations thereof. As discussed below, the controller 236 can comprise memory 502 including an operating system (OS) 504 and one or more standard applications 506. The standard applications 506 may include applications that provide for determining if a temperature is within a range or above/below a setpoint.

The controller 236 can also comprise one or more processors 510 and one or more of removable storage 512, non-removable storage 514, transceiver(s) 516, output device(s) 518, and input device(s) 520. In various implementations, the memory 502 can be volatile (such as random access memory (RAM)), non-volatile (such as read only memory (ROM), flash memory, etc.), or some combination of the two.

The memory 502 can also include the OS 504. The OS 504 varies depending on the manufacturer of the controller 236. The OS 504 contains the modules and software that support basic functions of the controller 236. The OS 504 can also enable the controller 236 to send and retrieve other data and perform other functions, such as transmitting control signals using the transceivers 516 and/or output devices 518 and receiving signals using the input devices 520, such the pump signal 246 and the valve signal 242.

The controller 236 can also comprise one or more processors 510. In some implementations, the processor(s) 510 can be one or more central processing units (CPUs), graphics processing units (GPUs), both CPU and GPU, or any other combinations and numbers of processing units. The controller 236 may also include additional data storage devices (removable and/or non-removable) such as, for example, magnetic disks, optical disks, or tape. Such additional storage is illustrated in FIG. 5 by removable storage 512 and non-removable storage 514.

Non-transitory computer-readable media may include volatile and nonvolatile, removable and non-removable tangible, physical media implemented in technology for storage of information, such as computer readable instructions, data structures, program modules, or other data. The memory 502, removable storage 512, and non-removable storage 514 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile discs (DVD) or other optical storage, magnetic cassettes, magnetic tape, magnetic disk storage or other magnetic storage devices, or any other tangible, physical medium which can be used to store the desired information, which can be accessed by the controller 236. Any such non-transitory computer-readable media may be part of the controller 236 or may be a separate database, databank, remote server, or cloud-based server.

In some implementations, the transceiver(s) 516 include any transceivers known in the art. In some examples, the transceiver(s) 516 can include wireless modem(s) to facilitate wireless connectivity with other components (e.g., between the controller 236 and a wireless modem that is a gateway to the Internet), the Internet, and/or an intranet. Specifically, the transceiver(s) 516 can include one or more transceivers that can enable the controller 236 to send and receive data. Thus, the transceiver(s) 516 can include multiple single-channel transceivers or a multi-frequency, multi-channel transceiver to enable the controller 236 to send and receive video calls, audio calls, messaging, etc. The transceiver(s) 516 can enable the controller 236 to connect to multiple networks including, but not limited to 2G, 3G, 4G, 5G, and Wi-Fi networks. The transceiver(s) 516 can also include one or more transceivers to enable the controller 236 to connect to future (e.g., 6G) networks, Internet-of-Things (IoT), machine-to machine (M2M), and other current and future networks.

The transceiver(s) 516 may also include one or more radio transceivers that perform the function of transmitting and receiving radio frequency communications via an antenna (e.g., Wi-Fi or Bluetooth®). In other examples, the transceiver(s) 516 may include wired communication components, such as a wired modem or Ethernet port, for communicating via one or more wired networks. The transceiver(s) 516 can enable the controller 236 to facilitate audio and video calls, download files, access web applications, and provide other communications associated with the systems and methods, described above.

In some implementations, the output device(s) 518 include any output devices known in the art, such as a display (e.g., a liquid crystal or thin-film transistor (TFT) display), a touchscreen, speakers, a vibrating mechanism, or a tactile feedback mechanism. Thus, the output device(s) can include a screen or display. The output device(s) 518 can also include speakers, or similar devices, to play sounds or ringtones when an audio call or video call is received. Output device(s) 518 can also include ports for one or more peripheral devices, such as headphones, peripheral speakers, or a peripheral display.

In various implementations, input device(s) 520 include any input devices known in the art. For example, the input device(s) 520 may include a camera, a microphone, or a keyboard/keypad. The input device(s) 520 can include a touch-sensitive display or a keyboard to enable users to enter data and make requests and receive responses via web applications (e.g., in a web browser), make audio and video calls, and use the standard applications 506, among other things. A touch-sensitive display or keyboard/keypad may be a standard push button alphanumeric multi-key keyboard (such as a conventional QWERTY keyboard), virtual controls on a touchscreen, or one or more other types of keys or buttons, and may also include a joystick, wheel, and/or designated navigation buttons, or the like. A touch sensitive display can act as both an input device 520 and an output device 518.

### Industrial Applicability

In various examples of the presently disclosed subject matter, a cooling tank 130 acts as a heat sink to remove heat from a secondary battery 118 while a power unit that provides electrical power to the work machine with batteries located in the power unit is unavailable for use. The size (volume) of the tank 130 and the temperature of the secondary battery coolant 216 in the tank 130 can be adjusted to provide for a certain period of cooling of the secondary battery 118 and/or cooling for a certain power level of the secondary battery 118. The secondary battery coolant 216 in the tank 130 may also be used to cool other components such as a buck boost inductor 117. The secondary battery coolant 216 in the tank 130 is cooled using an HVAC system 120 of the work machine 100 normally used to cool a cab 106 of the work machine 100. A portion of the refrigerant 214 used in the HVAC system 120 is directed to the chiller 220 of the battery cooling system 202. The chiller 220 is used to reduce the temperature of the secondary battery coolant 216. The volume of the secondary battery coolant 216 is used as a heat sink for the heat generated by the secondary battery 118, thus reducing the cooling load on the compressor 204 of the HVAC system 120. In some examples, the volume of the secondary battery coolant 216 is sufficient to reduce or eliminate the loading of the compressor 204 to cool the secondary battery 118 during the replacement of the power unit.

Using the heat sink provided by the (precooled) secondary battery coolant 216 stored in the tank 130 can provide some benefits. For example, the use of the heat sink can reduce the cooling load on the compressor 204, thus reducing the electrical load on the secondary battery 118 while the power unit 112 is not available. This can increase the power available by the secondary battery 118 that may be used for other electrical loads, such as moving the work machine 100. Further, in cases in which the power unit 112 may be unavailable for some time, the use of the heat sink provided by the secondary battery coolant 216 stored in the tank 130 can extend the time in which the battery temperature rises above a high setpoint, minimizing damage to the battery and increasing the safety of personnel and equipment proximate to the secondary battery 118.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A work machine, comprising:
a power unit configured to provide electrical power to a first set of electrical systems of the work machine;
a secondary battery configured to provide electrical power to a second set of electrical systems of the work machine; and
a work machine cooling system comprising:
a heating, ventilation, and cooling (HVAC) system configured to maintain a temperature of air within a cab of the work machine, wherein the HVAC system is further configured to provide at least a portion of a refrigerant to a battery cooling system; and
the battery cooling system, comprising:
a tank configured to store a volume of a secondary battery coolant, wherein the volume of the secondary battery coolant removes heat from the secondary battery when the power unit is unavailable for use;
a chiller configured to receive the refrigerant from the HVAC system, wherein the chiller is a heat exchanger configured to maintain a temperature of the secondary battery coolant in the tank within a range of temperatures; and
a tramming coolant pump in fluidic communication with the tank, wherein the tramming coolant pump is configured to pump the secondary battery coolant from the tank into the secondary battery to maintain a temperature of the secondary battery below a battery setpoint.

2. The work machine of claim 1, wherein the refrigerant from the HVAC comprises a compressible refrigerant and the secondary battery coolant comprises water or a water solution.

3. The work machine of claim 1, wherein the volume of the secondary battery coolant is determined based on a period of time to cool the secondary battery when the power unit is unavailable for use, a power level of the secondary battery when the power unit is unavailable for use.

4. The work machine of claim 1, further comprising a buck booster inductor, wherein the tramming coolant pump is further configured to pump at least a portion of the secondary battery coolant through the buck booster inductor to remove heat from the buck booster inductor.

5. The work machine of claim 1, further comprising a controller comprising:
a memory storing computer-executable instructions; and
a processor in communication with the memory, the computer-executable instructions causing the processor to perform acts comprising:
receiving an input that the power unit is unavailable for use, whereby the battery cooling system will be used to cool the secondary battery; and
receiving a cab cooling input and a secondary battery cooling input to cause the work machine cooling system to enter a configuration based on the cab cooling input and the secondary battery cooling input.

6. The work machine of claim 5, wherein the configuration is a first configuration based on the cab cooling input indicating that cab cooling is not required and a secondary battery cooling input indicating that secondary battery cooling is not required, wherein in the first configuration, the controller causes:
a compressor of the HVAC system to deenergize;
an HVAC expansion valve to close to reduce cooling to the cab; and
a tramming expansion valve to close to reduce cooling to the secondary battery coolant.

7. The work machine of claim 5, wherein the configuration is a second configuration based on the cab cooling input indicating that cab cooling is not required and a secondary battery cooling input indicating that secondary battery cooling is required, wherein in the second configuration, the controller causes:
a compressor of the HVAC system to cycle based on a temperature of the secondary battery coolant in the tank;
an HVAC expansion valve to close to reduce cooling to the cab; and
a tramming expansion valve to open to increase cooling to the secondary battery coolant.

8. The work machine of claim 5, wherein the configuration is a third configuration based on the cab cooling input indicating that cab cooling is required and a secondary battery cooling input indicating that secondary battery cooling is not required, wherein in the third configuration, the controller causes:
a compressor of the HVAC system to cycle based on a temperature of the air within the cab;
an HVAC expansion valve to open to increase cooling to the cab; and
a tramming expansion valve to close to decrease cooling to the secondary battery coolant.

9. The work machine of claim 5, wherein the configuration is a fourth configuration based on the cab cooling input indicating that cab cooling is required and a secondary battery cooling input indicating that secondary battery cooling is required, wherein in the fourth configuration, the controller causes:
a compressor of the HVAC system to cycle based on a temperature of the secondary battery coolant in the tank and a temperature of the air in the cab;
an HVAC expansion valve to open to increase cooling to the cab; and
a tramming expansion valve to open to increase cooling to the secondary battery coolant.

10. A controller configured to control a work machine cooling system of a work machine, the controller comprising:
a memory storing computer-executable instructions; and
a processor in communication with the memory, the computer-executable instructions causing the processor to perform acts comprising:
receiving an input that a power unit of the work machine is unavailable for use, whereby a battery cooling system of a work machine cooling system will be used to cool a secondary battery, wherein the work machine cooling system comprises:
a heating, ventilation, and cooling (HVAC) system configured to maintain a temperature of air within a cab of the work machine, wherein the HVAC system is further configured to provide at least a portion of a refrigerant to the battery cooling system when the power unit is unavailable for use; and
the battery cooling system, comprising:
a tank configured to store a volume of a secondary battery coolant, wherein the volume of the secondary battery coolant removes heat from the secondary battery when the power unit is unavailable for use;
a chiller configured to receive the refrigerant from the HVAC system, wherein the chiller is a heat exchanger configured to maintain a temperature of the secondary battery coolant in the tank within a range of temperatures; and
a tramming coolant pump in fluidic communication with the tank, wherein the tramming coolant pump is configured to pump the secondary battery coolant from the tank into the secondary battery to maintain a temperature of the secondary battery below a battery setpoint; and
receiving a cab cooling input and a secondary battery cooling input to cause the work machine cooling system to enter a configuration based on the cab cooling input and the secondary battery cooling input.

11. The controller of claim 10, wherein the configuration is a first configuration based on the cab cooling input indicating that cab cooling is not required and a secondary battery cooling input indicating that secondary battery cooling is not required, wherein in the first configuration, the controller causes:
a compressor of the HVAC system to deenergize;
an HVAC expansion valve to close to reduce cooling to the cab; and
a tramming expansion valve to close to reduce cooling to the secondary battery coolant.

12. The controller of claim 10, wherein the configuration is a second configuration based on the cab cooling input indicating that cab cooling is not required and a secondary battery cooling input indicating that secondary battery cooling is required, wherein in the second configuration, the controller causes:
a compressor of the HVAC system to cycle based on a temperature of the secondary battery coolant in the tank;
an HVAC expansion valve to close to reduce cooling to the cab; and
a tramming expansion valve to open to increase cooling to the secondary battery coolant.

13. The controller of claim 10, wherein the configuration is a third configuration based on the cab cooling input indicating that cab cooling is required and a secondary battery cooling input indicating that secondary battery cooling is not required, wherein in the third configuration, the controller causes:
a compressor of the HVAC system to cycle based on a temperature of the air within the cab;
an HVAC expansion valve to open to increase cooling to the cab; and
a tramming expansion valve to close to decrease cooling to the secondary battery coolant.

14. The controller of claim 10, wherein the configuration is a fourth configuration based on the cab cooling input indicating that cab cooling is required and a secondary battery cooling input indicating that secondary battery cooling is required, wherein in the fourth configuration, the controller causes:
a compressor of the HVAC system to cycle based on a temperature of the secondary battery coolant in the tank and a temperature of the air in the cab;
an HVAC expansion valve to open to increase cooling to the cab; and
a tramming expansion valve to open to increase cooling to the secondary battery coolant.

15. The controller of claim 10, wherein the work machine is an underground mining machine.

16. A method for controlling a work machine cooling system of a work machine, comprising:
receiving an input that a power unit of the work machine is unavailable for use, whereby a battery cooling system of a work machine cooling system will be used to cool a secondary battery, wherein the work machine cooling system comprises:
a heating, ventilation, and cooling (HVAC) system configured to maintain a temperature of air within a cab of the work machine, wherein the HVAC system is further configured to provide at least a portion of a refrigerant to the battery cooling system when the power unit is unavailable for use; and
the battery cooling system, comprising:
a tank configured to store a volume of a secondary battery coolant, wherein the volume of the secondary battery coolant removes heat from the secondary battery when the power unit is unavailable for use;
a chiller configured to receive the refrigerant from the HVAC system, wherein the chiller is a heat exchanger configured to maintain a temperature of the secondary battery coolant in the tank within a range of temperatures; and
a tramming coolant pump in fluidic communication with the tank, wherein the tramming coolant pump is configured to pump the secondary battery coolant from the tank into the secondary battery to maintain a temperature of the secondary battery below a battery setpoint; and
receiving a cab cooling input and a secondary battery cooling input to cause the work machine cooling system to enter a configuration based on the cab cooling input and the secondary battery cooling input.

17. The method of claim 16, wherein the configuration is a first configuration based on the cab cooling input indicating that cab cooling is not required and a secondary battery cooling input indicating that secondary battery cooling is not required, wherein in the first configuration, the controller causes:
a compressor of the HVAC system to deenergize;
an HVAC expansion valve to close to reduce cooling to the cab; and
a tramming expansion valve to close to reduce cooling to the secondary battery coolant.

18. The method of claim 16, wherein the configuration is a second configuration based on the cab cooling input indicating that cab cooling is not required and a secondary battery cooling input indicating that secondary battery cooling is required, wherein in the second configuration, the controller causes:
a compressor of the HVAC system to cycle based on a temperature of the secondary battery coolant in the tank;
an HVAC expansion valve to close to reduce cooling to the cab; and
a tramming expansion valve to open to increase cooling to the secondary battery coolant.

19. The method of claim 16, wherein the configuration is a third configuration based on the cab cooling input indicating that cab cooling is required and a secondary battery cooling input indicating that secondary battery cooling is not required, wherein in the third configuration, the controller causes:
a compressor of the HVAC system to cycle based on a temperature of the air within the cab;
an HVAC expansion valve to open to increase cooling to the cab; and
a tramming expansion valve to close to decrease cooling to the secondary battery coolant.

20. The method of claim 16, wherein the configuration is a fourth configuration based on the cab cooling input indicating that cab cooling is required and a secondary battery cooling input indicating that secondary battery cooling is required, wherein in the fourth configuration, the controller causes:
a compressor of the HVAC system to cycle based on a temperature of the secondary battery coolant in the tank and a temperature of the air in the cab;
an HVAC expansion valve to open to increase cooling to the cab; and
a tramming expansion valve to open to increase cooling to the secondary battery coolant.
